(19) United States
(12) Patent Application Publication
(10) Pub. No.: US 2008/0298498 A1
(43) Pub. Date: Dec. 4, 2008

(54) TRANSMITTING APPARATUS, RECEIVING APPARATUS, RADIO COMMUNICATION SYSTEM, TRANSMITTING METHOD, RECEIVING METHOD, COMMUNICATION METHOD AND PROGRAM

(75) Inventor: TAKUMI ITO, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 12/127,258

(22) Filed: May 27, 2008

(30) Foreign Application Priority Data
May 31, 2007 (JP) 2007-145178

(51) Int. Cl. H04L 27/00; H04L 27/06

(52) U.S. Cl. 375/295; 375/341

(57) ABSTRACT

A communication method for transmitting and receiving a coded signal is provided. In a transmitting end, the method holds (determines) control information for specifying an insertion position and an insertion amount to insert a redundant signal known to the receiving apparatus into an information data sequence, generates a coded signal sequence by encoding an information data sequence, generates a transmission signal by inserting the redundant signal into the coded signal sequence based on the held control information, and transmits the generated transmission signal. In a receiving end, the method receives the transmission signal as a received signal, holds likelihood information for a redundant signal contained in the received signal, calculates a likelihood from the received signal, substitutes the likelihood information for a likelihood corresponding to the redundant signal included in the calculated likelihood and demodulates the signal.

### INCORPORATION BY REFERENCE

This application is based upon and claims the benefit of priority from Japanese patent application No. 2007-145178, filed on May 31, 2007, the disclosure of which is incorporated herein in its entirety by reference.

### BACKGROUND OF THE INVENTION

1. Technical Field

The present invention relates to a radio communication system and, particularly, to a technique of signal transmission and reception.

2. Background Art

In radio communication, research and development of a technique to control radio parameters such as a code rate and a modulation method are conducted. It is already in practical use as in “Wireless LAN Medium Access Control and Physical Layer Specification: High-speed Physical Layer in the 5 GHz Band”, IEEE Std. 802.11a, 1999, for example.

FIG. 21 is an example of the configuration of a transmitting apparatus which implements radio parameter control.

A transmitting apparatus 21 includes a parameter control unit 2110, a coding unit 2120 and a mapping unit 430.

The parameter control unit 2110 controls a code rate of the coding unit 2120 by a parameter control signal Ctrl.

The coding unit 2120 receives an information bit string B, codes the information bit string B and outputs a coded sequence C.

The mapping unit 430 receives the coded sequence C, maps the coded sequence C into symbols and outputs a symbol sequence S.

The coding unit 2120 controls the code rate according to the parameter control signal Ctrl which is generated by the parameter control unit 2110. A tolerance to propagation path errors is thereby controlled, so that a communication speed changes.

An example of the configuration of a transmitting apparatus in a radio communication system which includes a plurality of antennas is described hereinafter. FIG. 22 is an example of a transmitting apparatus, in which the configuration of FIG. 21 is expanded to a transmitting apparatus that includes a plurality of antennas. Referring to FIG. 22, a transmitting apparatus 22 further includes a serial-parallel conversion unit 750 and two more mapping units 430 (i.e. three mapping units 430 in total) in addition to the elements of the transmitting apparatus 21. The other elements are substantially the same as those of the transmitting apparatus 21.

In the transmitting apparatus which includes a plurality of transmission antennas as shown in FIG. 22, each transmission signal generally reaches a receiver through a different propagation path. Thus, the ratio of received signal power and noise power (received SNR) differs among symbol sequences S0, S1 and S2. It is assumed that the received SNR of the symbol sequence S0 is sufficiently larger than the received SNR of the symbol sequences S2. A required received SNR is reduced by reducing the code rate to ½. This is a desirable change for the symbol sequences S2 with poor communication quality. On the other hand, this is an unnecessary decrease in the code rate for the symbol sequence S0 with good communication quality. As a result of such a change, excessive reduction of a communication speed occurs in the symbol sequences S0 and S1, and it is thus unnecessary parameter control for the symbol sequences S0 and S1.

Generally in a radio communication system, the reception performance is degraded by an interference signal due to multipath, noise power generated in a receiver and so on. Therefore, high-performance reception which reduces the degradation of reception performance is desired.

### SUMMARY

In light of the foregoing, it is an exemplary object of the present invention to provide a technique of transmitting and receiving a high-quality signal in radio communication.

According to an exemplary aspect of the invention, there is provided a transmitting apparatus to transmit a transmission signal to a receiving apparatus, which includes a redundant signal control unit to hold control information for specifying an insertion position and an insertion amount to insert a redundant signal known to the receiving apparatus into an information data sequence, and a signal coding unit to generate a coded signal sequence by encoding an information data sequence and generate a transmission signal by inserting the redundant signal into the coded signal sequence based on control information held by the redundant signal control unit.

According to an exemplary aspect of the invention, there is provided a receiving apparatus to receive a coded received signal, which includes a likelihood holding unit to hold likelihood information for specifying a likelihood of a redundant signal contained in the received signal, and a signal demodulation unit to receive the received signal containing the redundant signal and the likelihood information and demodulate the received signal by calculating a likelihood from the received signal and substituting the likelihood information for the likelihood of the redundant signal.

According to an exemplary aspect of the invention, there is provided a transmitting method to transmit a transmission signal to a receiving apparatus, which includes holding control information for specifying an insertion position and an insertion amount to insert a redundant signal known to the receiving apparatus into an information data sequence, generating a coded signal sequence by encoding an information data sequence, generating a transmission signal by inserting the redundant signal into the coded signal sequence based on held control information, and transmitting the generated transmission signal.

According to an exemplary aspect of the invention, there is provided a receiving method to receive a coded received signal, which includes holding likelihood information for specifying a likelihood of a redundant signal contained in the received signal, calculating a likelihood from the received signal, and demodulating the received signal by substituting the likelihood information for a likelihood corresponding to the redundant signal included in the calculated likelihood.

According to an exemplary aspect of the invention, there is provided a program for generating a transmission signal to be transmitted to a receiving apparatus, and the program causes a computer to implement a process which includes holding control information for specifying an insertion position and an insertion amount to insert a redundant signal known to the receiving apparatus into an information data sequence, generating a coded signal sequence by encoding an information data sequence, and generating a transmission signal by inserting the redundant signal into the coded signal sequence based on held control information.

According to an exemplary aspect of the invention, there is provided a program for demodulating a coded received signal, and the program causes a computer to implement a process which includes holding likelihood information for specifying a likelihood of a redundant signal contained in the received signal, calculating a likelihood from the received signal, generating a modified likelihood by substituting the likelihood information for a likelihood corresponding to the redundant signal included in the calculated likelihood, and demodulating the received signal based on the generated modified likelihood.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing an example of a transmitting apparatus according to an exemplary embodiment of the present invention;

FIG. 2 is a block diagram showing an example of a receiving apparatus according to an exemplary embodiment of the present invention;

FIG. 3 is a flowchart showing an example of processing in the transmitting apparatus and the receiving apparatus shown in FIGS. 1 and 2;

FIG. 4 is a block diagram showing an exemplary configuration of a transmitting apparatus according to a first exemplary embodiment of the present invention;

FIG. 5 is a block diagram showing an exemplary configuration of a receiving apparatus according to the first exemplary embodiment of the present invention;

FIG. 6 is a flowchart showing processing according to the first exemplary embodiment;

FIG. 7 is a view to describe the operation of a mapping unit;

FIG. 8 is a view to describe the operation of an inverse mapping unit;

FIG. 9 is a block diagram showing an exemplary configuration of a receiving apparatus according to a second exemplary embodiment of the present invention;

FIG. 10 is a flowchart to describe processing in the receiving apparatus according to the second exemplary embodiment;

FIG. 11 is a view to describe the exemplary advantage of a soft mapping unit;

FIG. 12 is a block diagram showing an exemplary configuration of a transmitting apparatus according to a third exemplary embodiment of the present invention;

FIG. 13 is a block diagram showing an exemplary configuration of a receiving apparatus according to the third exemplary embodiment of the present invention;

FIG. 14 is a flowchart to describe processing according to the third exemplary embodiment;

FIG. 15 is a block diagram showing an exemplary configuration of a mapping unit in FIG. 12;

FIG. 16 is a view to describe the operation of a mapping unit;

FIG. 17 is a block diagram showing an exemplary configuration of a signal demodulation unit according to a fourth exemplary embodiment of the present invention;

FIG. 18 is a block diagram showing an exemplary configuration of a replica generation unit in FIG. 17;

FIG. 19 is a view to describe the exemplary advantage of the replica generation unit in FIG. 17;

FIG. 20 is a block diagram showing an exemplary configuration of a redundant bit insertion unit according to a fifth exemplary embodiment of the present invention;

FIG. 21 is a block diagram showing an example of the configuration of a transmitting apparatus which implements radio parameter control; and

FIG. 22 is a block diagram showing an example of a transmitting apparatus, in which the configuration of FIG. 21 is expanded to a transmitting apparatus that includes a plurality of antennas.

### EXEMPLARY EMBODIMENT

Exemplary embodiments of the present invention will be described hereinbelow with reference to the drawings.

The description hereinbelow is appropriately shortened and simplified to clarify the explanation. In the drawings, the elements and equivalents having the same configuration or function are denoted by the same reference symbols, and the redundant explanation thereof will be omitted.

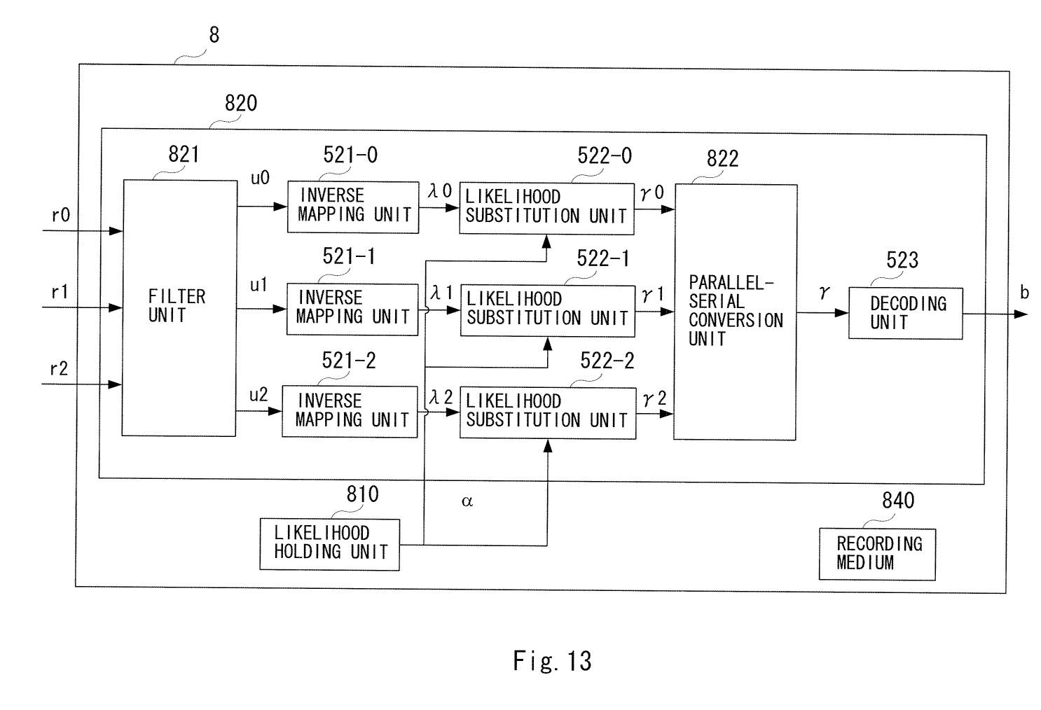

In this description, when there are a plurality of identical elements, which are to be distinguished from each other, the plurality of elements are distinguished by adding “−n” (n=0) to the symbol. For example, in FIG. 13, a plurality of likelihood substitution units 522-0 to 522-2 are illustrated. In the description with reference to FIG. 13, a likelihood substitution unit 522 indicates one or a plurality of the likelihood substitution units 522-0 to 522-2, and a likelihood substitution unit 522-n indicates each of a plurality of communication terminal apparatus which are distinguished from each other.

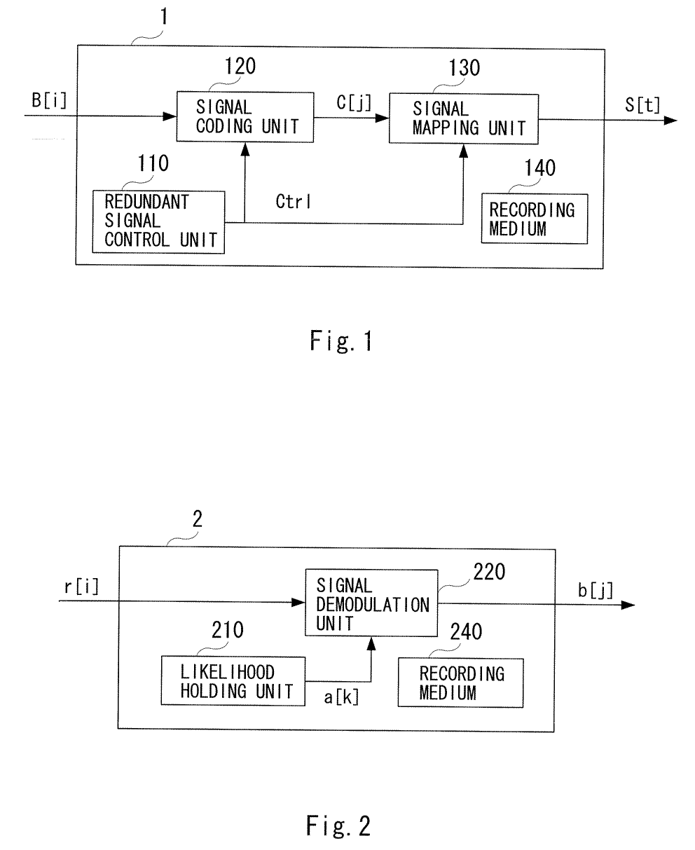

FIG. 1 is a block diagram showing an example of a transmitting apparatus according to an exemplary embodiment of the present invention, and FIG. 2 is a block diagram showing an example of a receiving apparatus according to an exemplary embodiment of the present invention.

Referring to FIG. 1, a transmitting apparatus 1 includes a redundant signal control unit 110, a signal coding unit 120, a signal mapping unit 130, and a recording medium 140.

The redundant signal control unit 110 determines an insertion position and an insertion amount of inserting a common redundant signal into a transmission signal, generates a control signal (control information) to control the determined insertion position and insertion amount and notifies it to the signal coding unit 120. The redundant signal control unit 110 includes a storage area to hold the generated control signal.

A common redundant signal is a redundant signal which is shared by a transmitting end and a receiving end. The value of a common redundant signal is commonly known to both transmitting and receiving ends. In the transmitting end, a common redundant signal which is inserted into a transmission signal is controlled by a control signal. In the receiving end, an insertion position and an insertion amount of a common redundant signal is notified in advance before decoding a received signal. A common redundant signal is also referred to as a redundant signal or a known signal, and it may be a common redundant bit or a common redundant symbol. Specifically, a common redundant signal may be a common redundant symbol which corresponds to each of coded symbols (complex symbols), or a common redundant bit which is one or more bits, as long as it is known in advance in both transmitting and receiving ends. In the following description, a common redundant signal to be inserted into a coded sequence is called a common redundant bit, and a common redundant signal to be inserted into mapped symbols is called a common redundant symbol.

The signal coding unit 120 encodes an information bit string (information data string) to be transmitted and outputs a coded sequence (coded signal sequence).

The signal mapping unit 130 maps the coded sequence which is encoded by the signal coding unit 120 into symbols and outputs a symbol sequence (transmission signal).

At least one of the signal coding unit 120 and the signal mapping unit 130 performs the insertion of a common redundant signal. A common redundant signal may be inserted into a coded sequence which is obtained by encoding an information data string by the signal coding unit 120. Alternatively, a common redundant signal may be inserted into a symbol sequence which is obtained by symbol-mapping a coded sequence by the signal mapping unit 130, that is, a generated transmission signal. In this manner, a common redundant symbol is inserted into an information bit string that is information to be transmitted from the transmitting end.

Referring to FIG. 2, a receiving apparatus 2 includes a likelihood holding unit 210, a signal demodulation unit 220, and a recording medium 240.

The likelihood holding unit 210 holds the likelihood of a common redundant signal as likelihood information. The likelihood holding unit 210 may generate the likelihood information based on a propagation path condition or it may hold a fixed value in advance. Alternatively, the likelihood holding unit 210 may hold a plurality of fixed values and select one piece of likelihood information from the plurality of fixed values based on a propagation path condition. The likelihood holding unit 210 includes a storage area to hold the likelihood information.

The signal demodulation unit 220 demodulates a received signal using the likelihood information which is held by the likelihood holding unit 210. Specifically, the signal demodulation unit 220 substitutes the likelihood information for the likelihood of a common redundant signal contained in the likelihood (calculated likelihood) that is determined by calculation in the signal demodulation unit 220 based on the received signal, and demodulates the received signal using a modified likelihood in which a part of the calculated likelihood is substituted by the likelihood information.

Each element in the transmitting apparatus 1 and the receiving apparatus 2 may be implemented by executing a program by the control of an arithmetic unit (not shown) which is included in each of the transmitting apparatus 1 and the receiving apparatus 2. Specifically, it may be implemented by loading a program which is stored in the recording medium 140 in the transmitting apparatus 1 or the recording medium 240 in the receiving apparatus 2 to a memory (not shown) and executing the program by the control of an arithmetic unit. Further, each of the above-described elements is not necessarily implemented by software by a program, and it may be implemented by any combination of hardware, firm ware and software or the like.

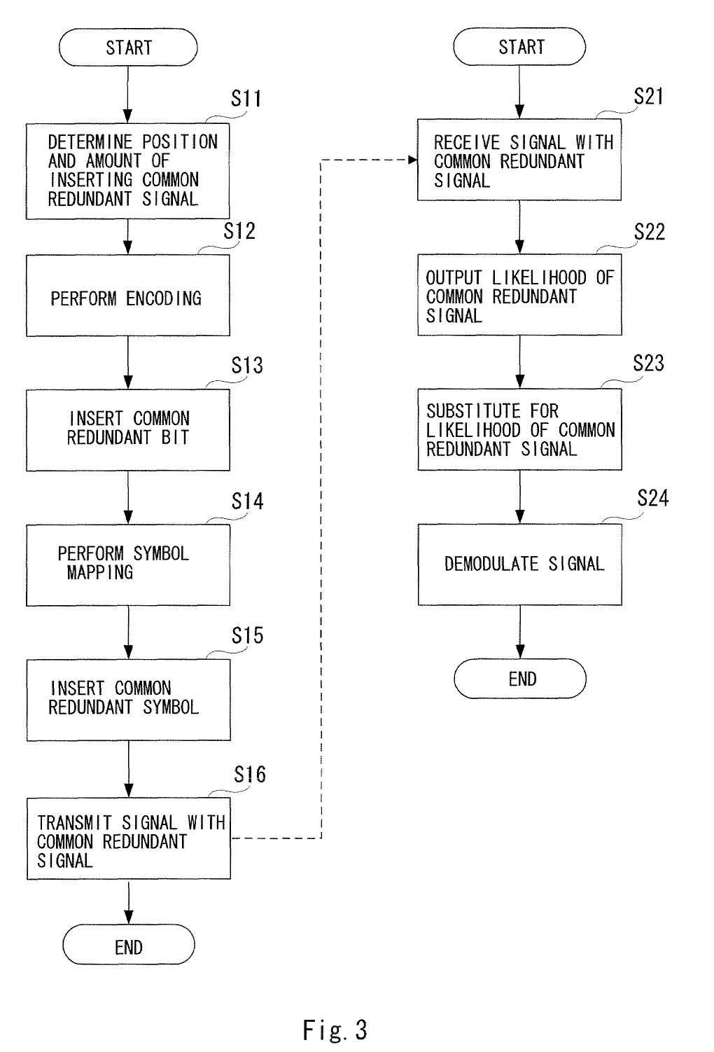

FIG. 3 is a flowchart showing an example of the processing according to this exemplary embodiment. The operation of the transmitting apparatus 1 and the receiving apparatus 2 according to this exemplary embodiment is described hereinafter with reference to FIGS. 1 to 3. In the followings, a case where the signal coding unit 120 inserts a common redundant bit and the signal mapping unit 130 inserts a common redundant symbol is described as an example. The symbols i, j, t and k are integers of 0 or above, which indicate the order of each piece of information.

The redundant signal control unit 110 determines the position and the amount of inserting a common redundant bit and a common redundant symbol and outputs a control signal Ctrl (Step S11). The signal coding unit 120 receives an information bit string B[i], encodes the information bit string B[i] (Step S12), inserts a common redundant bit into the coded information bit string and outputs a coded sequence C[j] (Step S13). The signal mapping unit 130 receives the coded sequence C[j], performs mapping of the coded sequence C[j] (Step S14), inserts a common redundant symbol and outputs a symbol sequence S[t] (Step S15). The transmitting apparatus 1 transmits a signal to which the common redundant signal is added through a transmitting unit (not shown) (Step S16).

The receiving apparatus 2 receives a received signal r[i] which contains the common redundant signal through a receiving unit (not shown) (Step S21). The received signal r[i] corresponds to the transmission signal (symbol sequence S) which is transmitted from the transmitting apparatus 1, and it contains the common redundant signal which is inserted by the transmitting apparatus 1. The likelihood holding unit 210 determines a likelihood of the common redundant signal and outputs likelihood information a[k] (Step S22). The signal demodulation unit 220 receives the received signal r[i] and the likelihood information a[k] and demodulates the received signal r[i]. At this time, the signal demodulation unit 220 substitutes the likelihood information a[k] for the likelihood (calculated likelihood) of the common redundant signal (the common redundant bit and the common redundant symbol) which is determined by calculation based on the received signal r [i] (Step S23). The signal demodulation unit 220 demodulates the received signal based on the likelihood (modified likelihood) which is partly substituted by the likelihood information a[k] (Step S24) and outputs a reproduced bit string b[j]

As described in the foregoing, according to this exemplary embodiment, the transmitting apparatus 1 generates a transmission signal by inserting a signal which is commonly known to the transmitting apparatus and the receiving apparatus, and the receiving apparatus 2 demodulates the signal by making substitution for the likelihood of a known signal. This enables easy and high-performance signal reception. Specifically, this significantly increases the probability of a common redundant signal. It is thereby possible to improve the overall correction capability in a decoder in a subsequent stage. For example, as a result of the substitution for the likelihood of a common redundant signal, a likelihood γ is a collection of likelihoods which are more probable than a likelihood λ. Consequently, a decoding unit performs decoding based on more probable information as a whole, thereby improving the correction capability.

The control signal which is determined by the redundant signal control unit 110 in the transmitting apparatus 1 is notified to the receiving apparatus 2 in advance before the receiving apparatus 2 performs decoding. The receiving apparatus 2 is configured so that an element to insert a common redundant signal is able to refer to the control signal in advance. For example, the likelihood holding unit may hold the control signal and output it together with the likelihood information.

In the exemplary process shown in FIG. 3, the signal mapping unit 130 inserts a common redundant symbol into mapped symbols. However, the present invention is not limited thereto, and the signal mapping unit 130 may insert a common redundant symbol into a coded sequence and then maps the coded sequence which contains the common redundant symbol into symbols. Further, the signal mapping unit 130 may use any of the common redundant bit and the common redundant symbol as a common redundant signal.

In the exemplary embodiments which are described hereinbelow, an example of a transmitting apparatus and a receiving apparatus which implements the above-described exemplary embodiment more specifically is described. The elements of the same name as those in FIGS. 1 and 2 have the same functions. Thus, the added or modified functions are mainly described hereinbelow. In all the exemplary embodiments below, an index of each signal is omitted in the description. Further, a case of inserting a common redundant bit as a common redundant signal is described hereinafter. However, this does not limit the invention, and a common redundant symbol may be used instead, or a common redundant bit and a common redundant symbol may be used in combination. Furthermore, although likelihood information is described as being a fixed value a regardless of a common redundant bit, a different value may be used for each bit. Although the receiving apparatus demodulates a received signal using a likelihood in the exemplary embodiments below, a log-likelihood ratio may be used instead of a likelihood.

### First Exemplary Embodiment

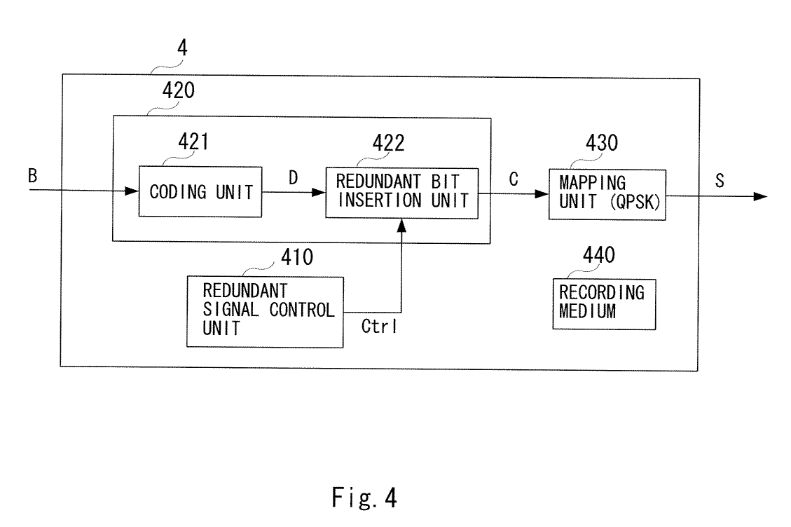

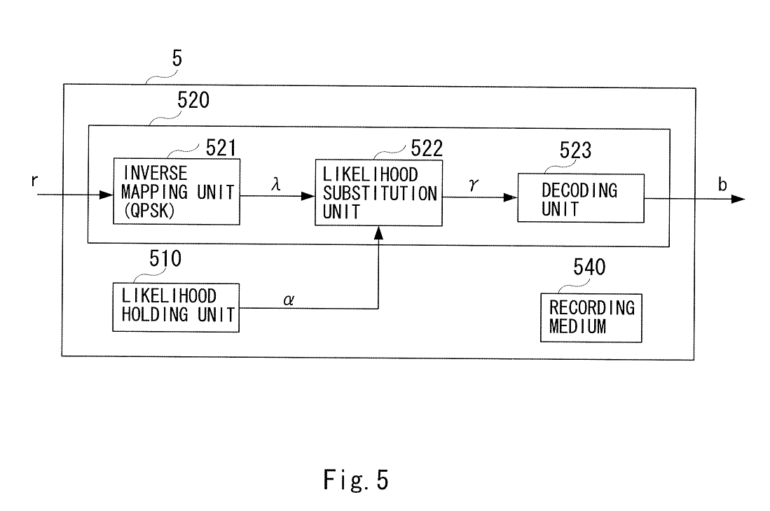

FIG. 4 is a block diagram showing an exemplary configuration of a transmitting apparatus according to a first exemplary embodiment of the present invention. FIG. 5 is a block diagram showing an exemplary configuration of a receiving apparatus according to the first exemplary embodiment of the present invention.

Referring to FIG. 4, a transmitting apparatus 4 includes a redundant signal control unit 410, a signal coding unit 420, a mapping unit 430, and a recording medium 440. The signal coding unit 420 includes a coding unit 421 and a redundant bit insertion unit 422. In this exemplary embodiment, a code rate which is used by the coding unit 421 is ⅔, and a symbol mapping which is used by the mapping unit 430 is QPSK.

The coding unit 421 encodes an information bit string B and outputs a coded sequence D.

The redundant bit insertion unit 422 receives a control signal Ctrl from the redundant signal control unit 410, inserts a common redundant bit into the coded sequence D which is encoded by the coding unit 421 based on the control signal Ctrl, and outputs a coded sequence C.

The mapping unit 430 maps the coded sequence C which is output from the redundant bit insertion unit 422 into QPSK symbols and outputs a mapped symbol sequence S.

Referring to FIG. 5, a receiving apparatus 5 includes a likelihood holding unit 510, a signal demodulation unit 520 and a recording medium 540. The signal demodulation unit 520 includes an inverse mapping unit 521, a likelihood substitution unit 522 and a decoding unit 523.

The likelihood holding unit 510 holds a fixed value a as the likelihood of a common redundant signal (which is a common redundant bit in this example). In the following description, the likelihood which is held by the likelihood holding unit 510 is referred to as likelihood information a.

The inverse mapping unit 521 performs inverse mapping from the QPSK symbol sequence of the received signal r into the likelihood of each bit and outputs a likelihood λ (calculated likelihood).

The likelihood substitution unit 522 outputs a likelihood γ (modified likelihood) in which a part of the likelihood λ is substituted by the likelihood information. Specifically, the likelihood substitution unit 522 substitutes the fixed value a which is held by the likelihood holding unit 510 for the likelihood of the common redundant bit that is included in the likelihood λ which is calculated by the inverse mapping unit 521, and outputs the likelihood γ.

The decoding unit 523 decodes the received signal based on the likelihood γ.

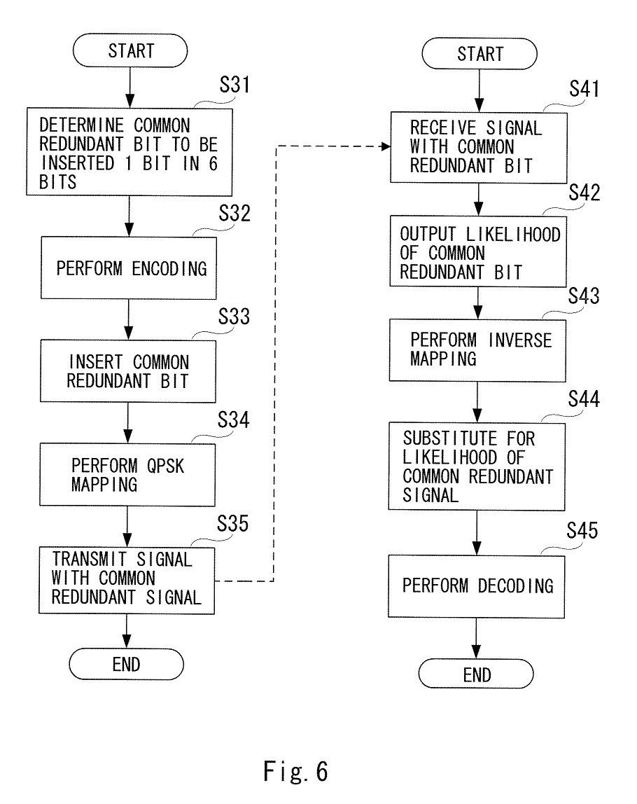

FIG. 6 is a flowchart showing the processing according to the first exemplary embodiment. The operation according to the first exemplary embodiment is described hereinafter with reference to FIGS. 4 to 6. The processing may be implemented by executing a program which is stored in the recording media 440 and 540 by an arithmetic unit (not shown) which is included in the transmitting apparatus 4 and the receiving apparatus 5, for example.

Firstly, the redundant signal control unit 410 determines that a common redundant bit is to be inserted once in 6 bits, and outputs a control signal Ctrl (Step S31). The coding unit 421 receives an information bit string B, encodes the information bit string B at a code rate of ⅔ (Step S32), and outputs a coded sequence D. The redundant bit insertion unit 422 receives the coded sequence D and the control signal Ctrl, inserts a common redundant bit into the coded sequence D based on the control signal Ctrl (Step S33) and outputs a coded sequence C.

For example, if the information bit string B is 8 bits (B [0]B[1]B[2]B[3]B[4]B[5]B[6]B[7]), a coded sequence D is 12 bits (D[0]D[1]D[2]D[3]D[4]D[5]D[6]D[7]D[8]D[9]D[10]D[11]). The redundant bit insertion unit 422 inserts a bit “0” as a common redundant bit twice into the coded sequence D so that C[0]C[1]C[2]C[3]C[4]C[5]C[6]C[7]C[8]C[9]C[10]C[11]C[12]C[13]=D[0]D[1]D[2]D[3]D[4]“0”D[5]D[6]D[7]D[8]D[9]“0”D[10]D[11]. “0” indicates a common redundant bit.

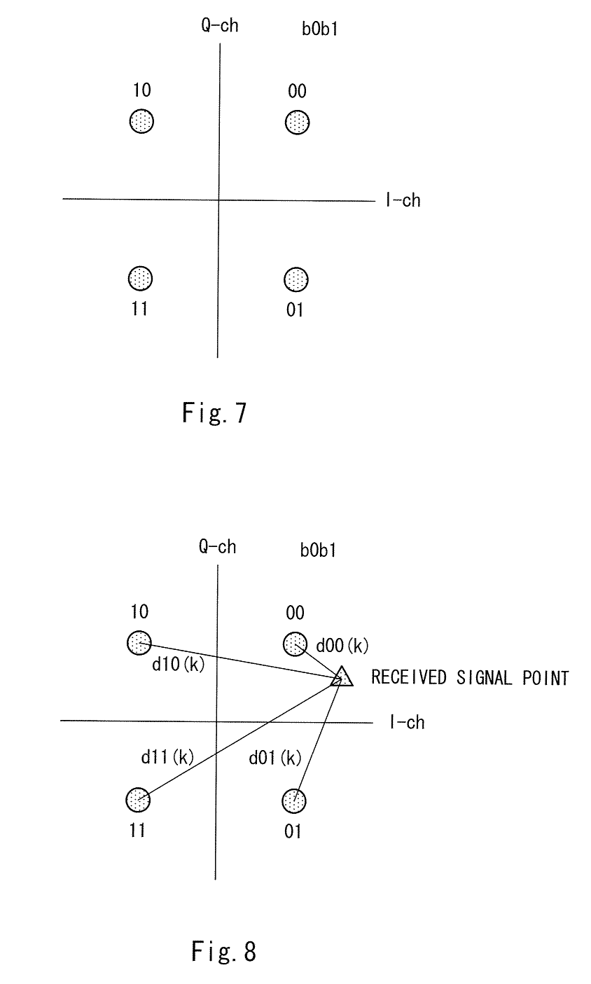

Next, the mapping unit 430 receives the coded sequence C and maps the coded sequence C into QPSK symbols as shown in FIG. 7 (Step S34). The transmitting apparatus 4 transmits the generated symbols (Step S35).

The receiving apparatus 5 receives a received signal r to which the common redundant bit is added (Step S41). The likelihood holding unit 510 outputs a fixed value a as the likelihood of the common redundant bit (Step S42). The inverse mapping unit 521 performs inverse mapping from the QPSK symbols into the likelihood for each bit (Step S43) and outputs a likelihood λ. The likelihood substitution unit 522 receives the likelihood information a and the likelihood λ and substitutes the likelihood information a for the likelihood of the common redundant bit (Step S44). The likelihood substitution unit 522 outputs a likelihood γ which is partly substituted by the likelihood information a. The decoding unit 523 receives the likelihood γ and decodes the received signal using the likelihood γ (Step S45) and outputs a reproduced string b.

The operation of the likelihood substitution unit 522 is described hereinafter. The calculation of the likelihood λ may be performed by using a square distance to each bit as shown in FIG. 8, for example. In FIG. 8, a circular mark indicates a transmission symbol position (transmission symbol constellation), and a triangular mark indicates a received symbol position. d00(k) indicates a square distance between a symbol at b0=0, b1=0 and a received symbol position. The likelihood λ for a bit b0 can be calculated as λ=min{d10(k), d11(k)}−min{d00(k), d01(k)}.

When SNR is sufficiently high, a received signal point corresponds to any of the transmission symbol, and any of d00 to d11 is supposed to be 0. However, as shown in FIG. 8, the received signal point generally does not correspond to a transmission symbol position due to the effects of noise and interference. As for a common redundant bit, it is known that the bit is 0 in the receiving apparatus also. Thus, the likelihood of the bit is substituted so that the probability of the bit 0 is sufficiently high. It is thereby possible to expect the improvement in error correction capability in a decoder in a subsequent stage.

For example, when a line quality is poor, the further improvement in error correction capability can be expected by increasing the amount of common redundant signals to be inserted. Consequently, the achievement of a certain level of signal transmission can be expected. On the other hand, when a line quality is good, the transmission of a large number of signals can be expected while ensuring a certain level of error correction capability by decreasing the amount of common redundant signals to be inserted. In this manner, it is possible to perform adaptive transmission according to the quality of a propagation path by controlling a common redundant signal.

If the bit b0 is 0, it is supposed to be min{d00(k), d01(k)}=0. Thus, the likelihood λ for the bit b0 is λ=a, and the calculated value of the likelihood λ is substituted by the likelihood information a. It is thereby possible to set the likelihood from which the effects of noise and interference are eliminated. Consequently, high-quality signal reception can be expected.

As described in the foregoing, according to this exemplary embodiment, the receiving apparatus receives a signal with a high reception quality (less error) by receiving a signal that contains a common redundant bit having a known value. It is thereby possible to achieve high-quality signal reception.

Although the insertion position of a common redundant bit has a periodicity of once in 6 times in this exemplary embodiment, such periodicity does not limit the present invention in any way. Further, there are no particular restrictions in the determination of the frequency of inserting a common redundant bit, and it may be determined appropriately according to the condition of a communication path.

Although FIG. 4 shows the case where the signal coding unit 420 inserts a common redundant bit, the following configurations may be possible in the case of inserting a common redundant bit when the mapping unit 430 performs symbol mapping. For example, a redundant symbol insertion unit that inserts a common redundant symbol into the symbol sequence S which is output from the mapping unit 430 may be provided. Alternatively, a redundant bit insertion unit that inserts a common redundant bit into the coded sequence C which is output from the signal coding unit 420 may be provided.

Further, the transmitting apparatus may include a redundant signal insertion unit that inserts a common redundant signal based on a control signal, instead of the redundant bit insertion unit shown in FIG. 4. The redundant signal insertion unit may have a configuration that determines the kind of a common redundant signal based on a control signal and inserts either one of a common redundant bit or a common redundant symbol, for example, based on the determination result.

### Second Exemplary Embodiment

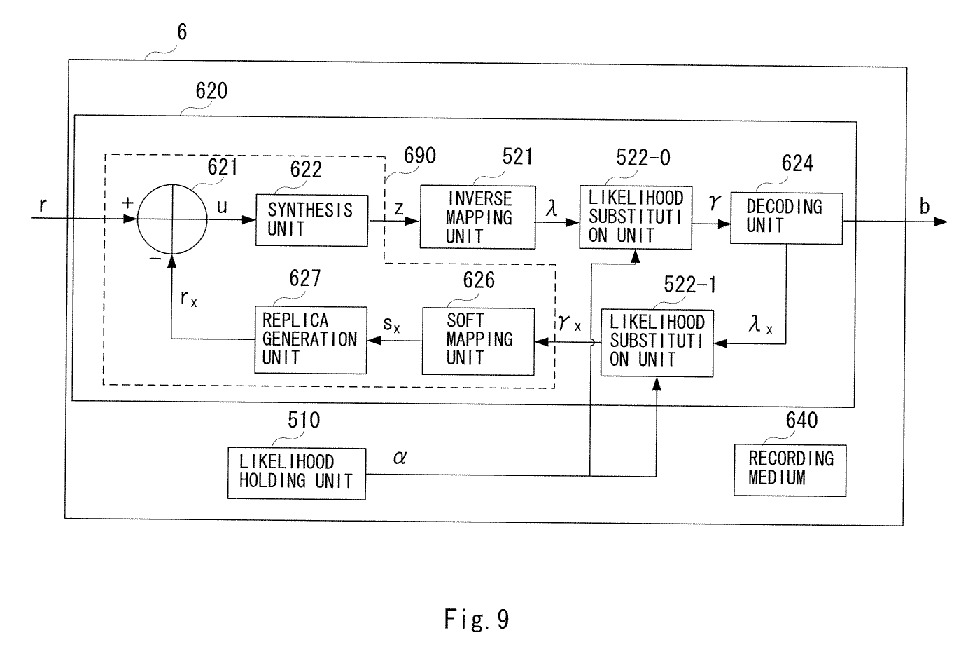

In the second exemplary embodiment, an exemplary aspect where a receiving apparatus 6 performs demodulation based on a signal after eliminating an interference wave or the like from a received signal is described. In the second exemplary embodiment, the receiving apparatus 6 shown in FIG. 9 is used instead of the receiving apparatus 5 shown in FIG. 5. The transmitting apparatus 1 is the same. Thus, the receiving apparatus 6 is described hereinafter.

FIG. 9 is a block diagram showing an exemplary configuration of the receiving apparatus according to the second exemplary embodiment. Referring to FIG. 9, the receiving apparatus 6 includes a likelihood holding unit 510, a signal demodulation unit 620 and a recording medium 640. The signal demodulation unit 620 includes an elimination unit 621, a synthesis unit 622, an inverse mapping unit 521, a decoding unit 624, likelihood substitution units 522-0 and 522-1, a soft mapping unit 626, and a replica generation unit 627. In FIG. 9, u indicates an elimination signal, λₓ and λₓ indicate a likelihood, sₓ indicates a soft symbol, and rₓ indicates a replica signal.

The elimination unit 621 outputs an elimination signal u by eliminating a replica signal rₓ from a received signal r.

The synthesis unit 622 receives the elimination signal u from the elimination unit 621 and performs synthesis so as to suppress an interference component in the elimination signal u. Thus, the synthesis unit 622 synthesizes the elimination signal u so as to reduce a residual interference.

The likelihood substitution unit 522-0 (first likelihood substitution unit) substitutes a fixed value a which is held by the likelihood holding unit 510 for the likelihood of a common redundant bit which is included in the likelihood λ and outputs a likelihood γ in which a part of the likelihood λ is substituted.

The decoding unit 624 decodes the received signal based on the likelihood γ and further recalculates a likelihood based on the likelihood γ and outputs a likelihood λₓ (second calculated likelihood).

The likelihood substitution unit 522-1 (second likelihood substitution unit) substitutes the fixed value a which is held by the likelihood holding unit 510 for the likelihood of the common redundant bit which is included in the likelihood λₓ that is calculated by the decoding unit 624 and outputs a likelihood γₓ (second modified likelihood) in which a part of the likelihood λₓ is substituted.

The soft mapping unit 626 calculates a soft symbol sₓ based on the likelihood γₓ. The replica generation unit 627 generates a replica signal rₓ of an interference wave based on the soft symbol sₓ which is calculated by the soft mapping unit 626 and outputs the generated replica signal rₓ to the elimination unit 621.

The elements which generate an elimination signal based on the likelihood γₓ that is output from the likelihood substitution unit 522-1 and output it to the inverse mapping unit 521 may be collectively referred to as an elimination signal generation unit 690. In the configuration of FIG. 9, the elimination signal generation unit 690 includes the elimination unit 621, the synthesis unit 622, the soft mapping unit 626 and the replica generation unit 627. However, the elimination signal generation unit 690 is not limited to include those elements, as long as it is an element which generates an elimination signal by eliminating an interference wave from a received signal based on the likelihood γₓ (second modified likelihood).

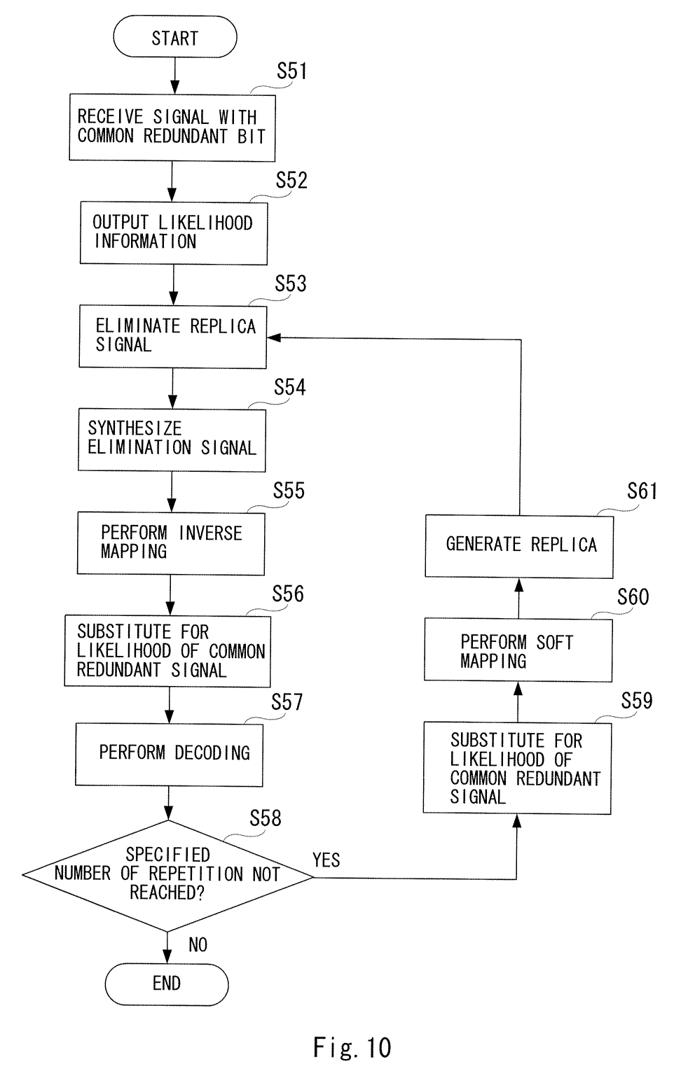

FIG. 10 is a flowchart showing the processing in the receiving apparatus according to the second exemplary embodiment.

The operation according to the second exemplary embodiment is described hereinafter with reference to FIGS. 9 and 10. The processing may be implemented by executing a program which is stored in the recording media 640 that is included in the receiving apparatus 6 by an arithmetic unit (not shown) in the receiving apparatus 6, for example. The receiving apparatus 6 receives a received signal r to which a common redundant bit is added (Step S51). The likelihood holding unit 510 outputs likelihood information a (Step S52). The elimination unit 621 subtracts the replica signal rₓ from the received signal r and outputs an elimination signal u (Step S53). The synthesis unit 622 receives the elimination signal u, synthesizes the elimination signal u so as to suppress an interference component and outputs a synthesized signal z (Step S54). The inverse mapping unit 521 receives the synthesized signal z, calculates a likelihood λ by performing inverse mapping of the synthesized signal z and outputs the calculated likelihood λ (Step S55). The likelihood substitution unit 522-0 receives the likelihood λ and the likelihood information a, substitutes the likelihood information a for the likelihood of a common redundant bit which is included in the likelihood λ and outputs a likelihood γ (Step S56). The decoding unit 624 receives the likelihood γ, decodes the likelihood γ and outputs the likelihood λₓ and a reproduced string b (Step S57). The decoding unit 624 then determines whether the number of repetition reaches a specified number and, if it is equal to or smaller than a specified number, the process performs the following processing in succession (Step S58).

The likelihood substitution unit 522-1 receives the likelihood information a and the likelihood λₓ, substitutes the likelihood information a for the likelihood of a common redundant bit and outputs a likelihood γₓ (Step S59). The soft mapping unit 626 receives the likelihood γₓ and generates and outputs a soft symbol sₓ (Step S60). The replica generation unit 627 receives the soft symbol sₓ and generates and outputs a replica signal rₓ (Step S61). Subsequently, the process repeats the processing from Step S53.

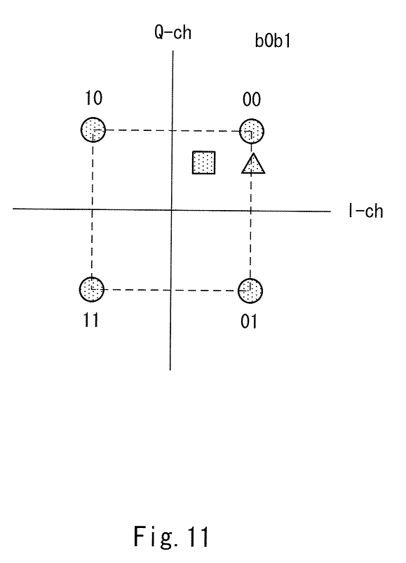

The exemplary advantage of the likelihood substitution unit 522-0 is the same as described in the first exemplary embodiment. Therefore, the exemplary advantage of the likelihood substitution unit 522-1 is described hereinafter. FIG. 11 is a view showing output symbols from the soft mapping unit 626. In FIG. 11, a rectangular mark indicates a soft symbol when likelihood substitution is not performed, and a triangular mark indicates a soft symbol when likelihood substitution is performed for b0. The likelihood substitution unit 522-1 performs substitution for b0 so that the probability of b0=0 is sufficiently high. As a result, an Ich component of a soft symbol which is generated by the soft mapping unit 626 corresponds to an Ich component of a transmission symbol. This allows the elimination unit 621 to sufficiently eliminate an Ich interference component.

As described in the foregoing, this exemplary embodiment enables the improvement in error correction capability by making substitution for the likelihood to be input to the decoding unit 624 (decoder). It further increases the effect of eliminating an interference by making substitution for the likelihood to be input to the soft mapping unit 626.

### Third Exemplary Embodiment

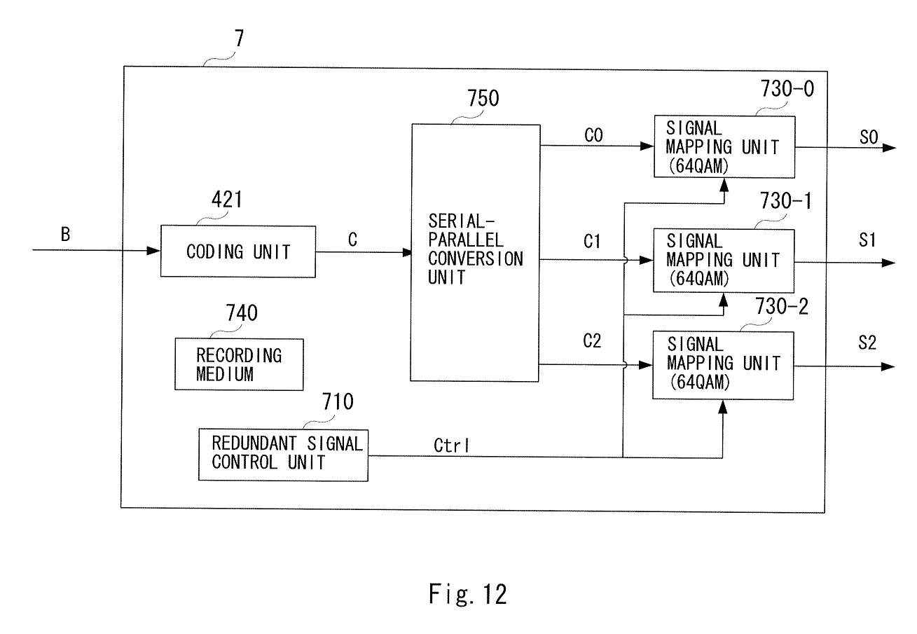

In the third exemplary embodiment, an exemplary aspect where a plurality of propagation paths have different line qualities is described. FIG. 12 is a block diagram showing an exemplary configuration of a transmitting apparatus 7 according to the third exemplary embodiment. FIG. 13 is a block diagram showing an exemplary configuration of a receiving apparatus 8 according to the third exemplary embodiment.

Referring to FIG. 12, the transmitting apparatus 7 includes a redundant signal control unit 710, a coding unit 421, a serial-parallel conversion unit 750, signal mapping units 730-0, 730-1 and 730-2, and a recording medium 740.

The redundant signal control unit 710 generates and outputs a plurality of pieces of control information which respectively correspond to a plurality of different propagation paths. If the line qualities of the plurality of propagation paths are the same, the redundant signal control unit 710 outputs the same control information to each of the plurality of signal mapping units 730.

The serial-parallel conversion unit 750 receives the coded sequence C from the coding unit 421, converts the coded sequence C into parallel and outputs a plurality of coded sequences C0 to C2.

The signal mapping units 730 respectively receive the plurality of coded sequences C and perform mapping. At this time, a common redundant signal is inserted into each coded sequence C based on the control signal corresponding to each propagation path. The signal mapping units 730 are described in detail later.

Referring to FIG. 13, the receiving apparatus 8 includes a likelihood holding unit 810, a signal demodulation unit 820 and a recording medium 840. The signal demodulation unit 820 includes a filter unit 821, inverse mapping units 521-0, 521-1 and 521-2, likelihood substitution units 522-0, 522-1 and 522-2, a parallel-serial conversion unit 822, and a decoding unit 523.

The likelihood holding unit 810 output likelihood information which corresponds to each of the different propagation paths to each of the plurality of likelihood substitution units 522.

The filter unit 821 calculates synthesized sequences u0, u1 and u2 from received signals r0, r1 and r2 using a filter which operates based on predetermined criteria. The predetermined criteria may be a least mean-square error, for example.

The parallel-serial conversion unit 822 converts a plurality of likelihoods γ0 to γ2 into serial and outputs one likelihood γ.

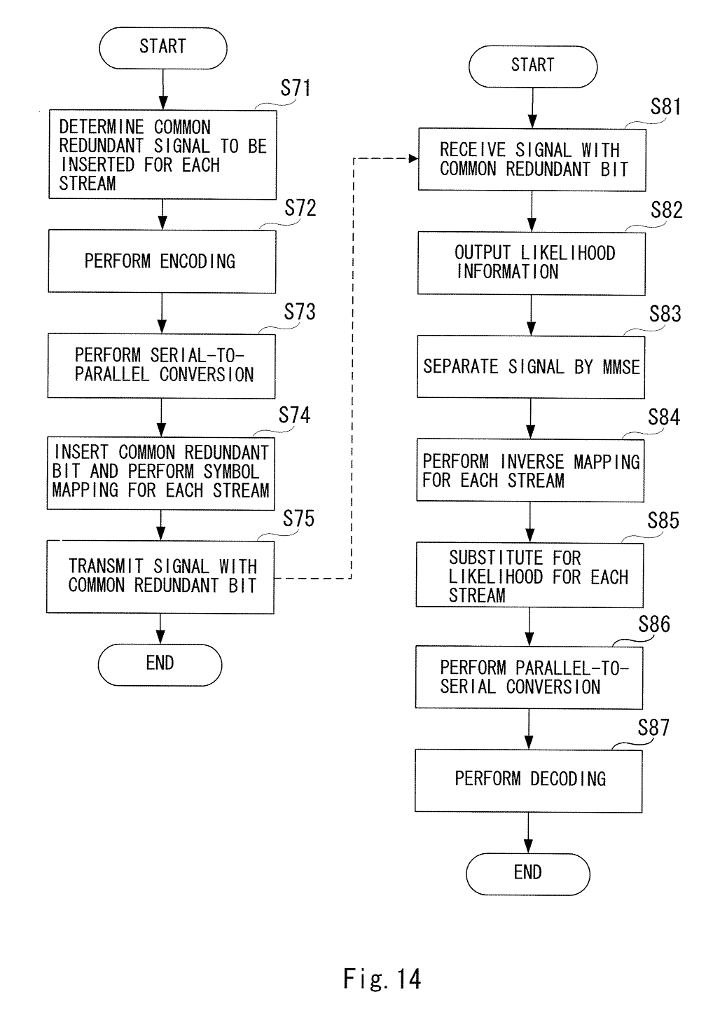

FIG. 14 is a flowchart showing the processing according to the third exemplary embodiment. The processing of FIG. 14 may be implemented by executing a program which is stored in the recording media 740 and 840 by an arithmetic unit (not shown) which is included in the transmitting apparatus 7 and the receiving apparatus 8, for example. The operation according to the third exemplary embodiment is described hereinafter with reference to FIGS. 12 to 14. In the following description, the line quality is highest in the stream 0, second-highest in the stream 1, and lowest in the stream 2.

The transmitting apparatus 7 receives an information bit string B. The redundant signal control unit 710 determines the amount of common redundant bits to be inserted into the streams 0, 1 and 2 to be once in 16 bits, once in 12 bits, and once in 8 bits, respectively, and outputs a control signal Ctrl indicating it (Step S71). The amount of common redundant bits is different among steams because the amount of common redundant bits to be inserted is adjusted according to line qualities. This reduces the need to change a code rate or a modulation method for a poor line quality. It is thereby possible to maintain a transmission rate of a propagation path with a good line quality.

The coding unit 421 receives an information bit string B, encodes the information bit string B and outputs a coded sequence C (Step S72). The serial-parallel conversion unit 750 converts the coded sequence C from serial to parallel and outputs coded sequences C0, C1 and C2 (Step S73).

The signal mapping units 730-0, 730-1 and 730-2 receive the coded sequences C0, C1 and C2, respectively, and the control signal Ctrl, performs mapping into 64QAM symbols and outputs symbol sequences S0, S1 and S2 (Step S74). The signal mapping units 730-0, 730-1 and 730-2 respectively generate and output the symbol sequences S0, S1 and S2 having the same symbol rate. Because of the same symbol rate, demodulation processing can be performed in the receiving apparatus.

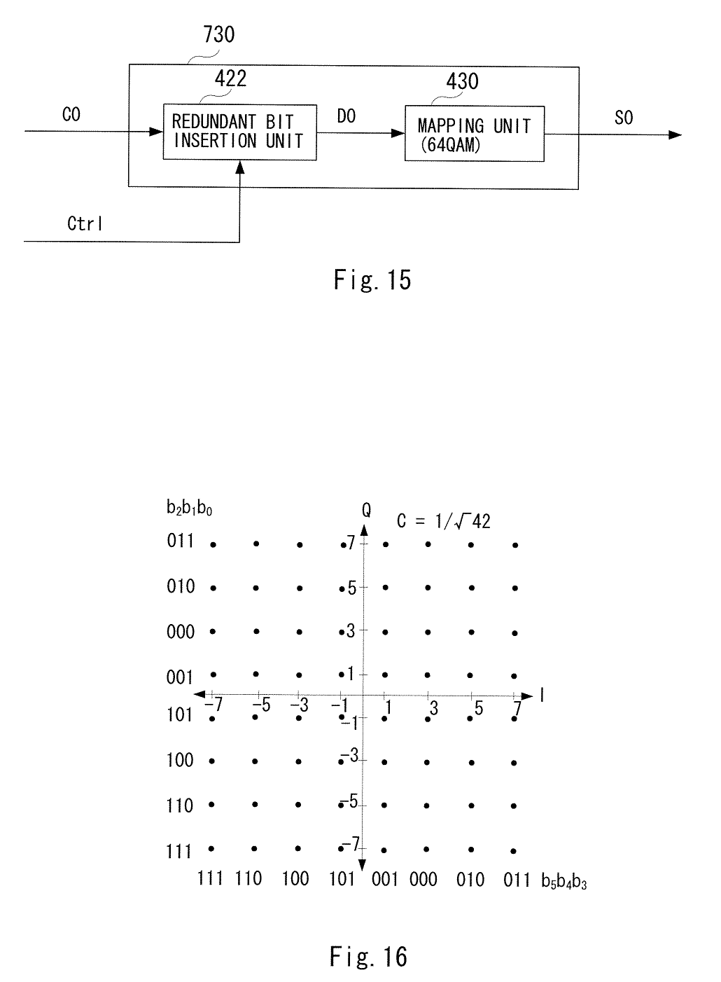

FIG. 15 shows an exemplary configuration of the signal mapping unit 730. Referring to FIG. 15, the signal mapping unit 730 includes a redundant bit insertion unit 422 and a mapping unit 430. The stream 0 is described below as an example.

The redundant bit insertion unit 422 inserts a bit “0” into the coded sequence C0[0]C0[1] . . . at a rate of once in 16 bits so that D0[0]D0[1] . . . =C0[0]C0[1] . . . C0[15]“0”C0[16]C0[17] . . . C0[31]“0”C0[32] . . . .

The mapping unit 430 maps the coded sequence D0 into 64QAM symbols in accordance with the mapping rule shown in FIG. 16.

The transmitting apparatus 7 transmits the symbol sequences S0, S1 and S2 (Step S75).

The receiving apparatus 8 receives signals r0, r1 and r2 which include common redundant bits (Step S81). The likelihood holding unit 810 outputs a fixed value a as the likelihood of the common redundant bit (Step S82). The filter unit 821 receives the received signals r0 to r2, separates the received signals and outputs synthesized sequences u0 to u2 (Step S83). The inverse mapping units 521-0, 521-1 and 521-2 receive the synthesized sequences u0 to u2, perform inverse mapping from the synthesized sequences u0 to u2 into the likelihood of each bit, and output likelihoods λ0, λ1 and λ2 (Step S84). The likelihood substitution units 522-0, 522-1 and 522-2 substitute the fixed value a for the likelihoods λ0, λ1 and λ2 of the common redundant bits and output likelihoods γ0, γ1 and γ2 (Step S85). In this step, the likelihood substitution units 522-0, 522-1 and 522-2 make substitution for the likelihoods λ0, λ1 and λ2 once in 16 bits, once in 12 bits and once in 8 bits, respectively.

The parallel-serial conversion unit 822 converts the likelihoods γ0, γ1 and γ2 from parallel to serial and outputs a likelihood γ (Step S86). The decoding unit 523 receives the likelihood γ, decodes the received signal using the likelihood γ and outputs a reproduced string b (Step S87).

As described in the foregoing, this exemplary embodiment enables the determination of the amount of common redundant bits to be inserted for each stream in addition to having the exemplary advantage of the first exemplary embodiment. It is thereby possible to expect efficient communication according to line qualities.

### Fourth Exemplary Embodiment

A fourth exemplary embodiment of the present invention also describes the case of receiving received signals from a plurality of propagation paths as in the third exemplary embodiment. However, in the fourth exemplary embodiment, a signal demodulation unit 920 having a different internal configuration from the signal demodulation unit 820 of the third exemplary embodiment is described.

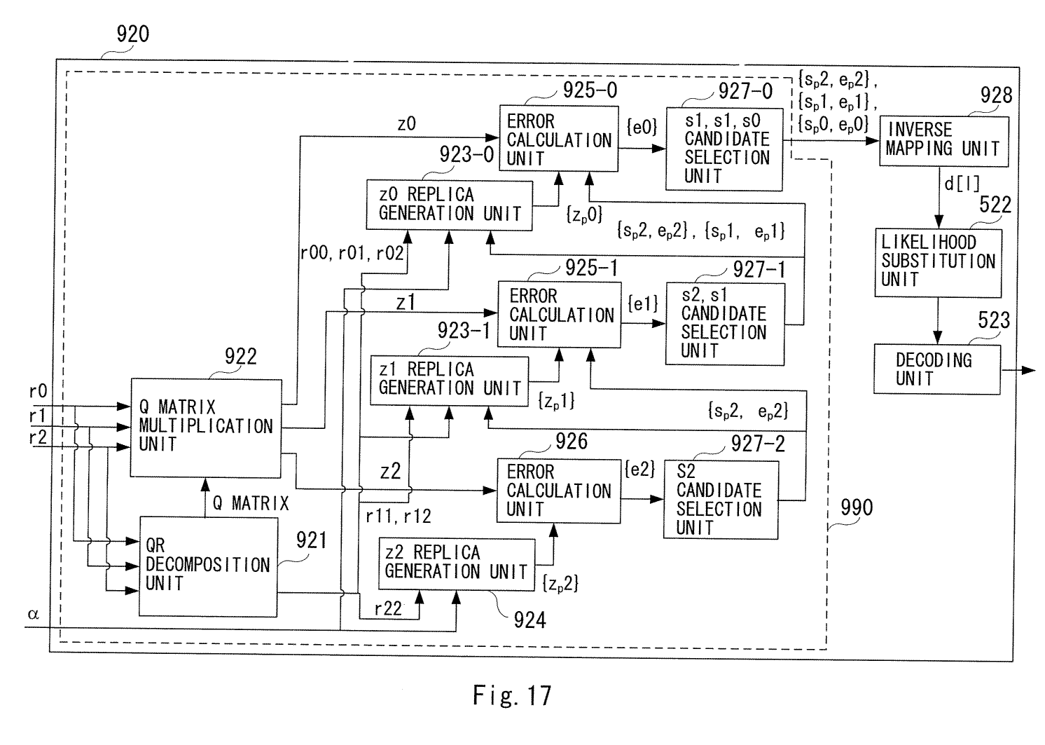

FIG. 17 is a block diagram showing an exemplary configuration of the signal demodulation unit 920. The block diagram of FIG. 17 shows the configuration on the basis of a simplified MLD (Maximum Likelihood Detection) algorithm using the QR decomposition. The detail of the algorithm is described in Hiroyuki KAWAI, Kenichi HIGUCHI, Noriyuki MAEDA, Mamoru SAWAHASHI, Takumi ITO, Yoshikazu KAKURA, Akihisa USHIROKAWA, Hiroyuki SEKI, “Likelihood Function for QRM-MLD Suitable for Soft-Decision Turbo Decoding and Its Performance for OFCDM MIMO Multiplexing in Multipath Fading Channel”, IEICE TRANS. Commun., Vol.E88-B, No. 1, January 2005.

Referring to FIG. 17, the signal demodulation unit 920 includes a QR decomposition unit 921, a Q matrix multiplication unit 922, replica generation units 923-0, 923-1 and 924, error calculation units 925-0, 925-1 and 926, candidate selection units 927-0, 927-1 and 927-2, an inverse mapping unit 928, a likelihood substitution unit 522, and a decoding unit 523. Each of the candidate selection units 927-0, 927-1 and 927-2 selects 16 candidates.

The QR decomposition unit 921 receives signals r0, r1 and r2, performs QR decomposition of the channel matrix between the transmitting and receiving apparatus and outputs a Q matrix and active components r00, r01, r02, r11, f12 and f22 of an R matrix.

The Q matrix multiplication unit 922 receives the received signals r0, r1 and r2 and the Q matrix, generates nulling signals z0, z1 and z2 by multiplying a complex conjugate transpose of the Q matrix and outputs them.

The replica generation unit 924 receives r22 and likelihood information a and outputs a replica sequence {zₚ2} of z2.

The error calculation unit 926 receives the nulling signal z2 and the replica sequence {zₚ2} and outputs an error sequence {e2}.

The candidate selection unit 927-2 receives the error sequence {e2} and outputs a 16-symbol candidate sequence {sₚ2} with a small error and an error sequence {eₚ2} of the candidate sequence.

Likewise, the replica generation unit 923-1, the error calculation unit 925-1 and the candidate selection unit 927-1 calculate and output symbol candidate sequences {sₚ2} {sₚ1} and their error sequences {eₚ2} {eₚ1}.

The replica generation unit 923-0, the error calculation unit 925-0 and the candidate selection unit 927-0 calculate and output symbol candidate sequences {sₚ2} {sₚ1} {sₚ0} and their error sequences {eₚ2} {eₚ1} {eₚ0}.

The inverse mapping unit 928 receives the symbol candidate sequences {sₚ2} {sₚ1} {sₚ0} and the error sequences {eₚ2} {eₚ1} {eₚ0} and calculate and output the likelihood of each coded bit.

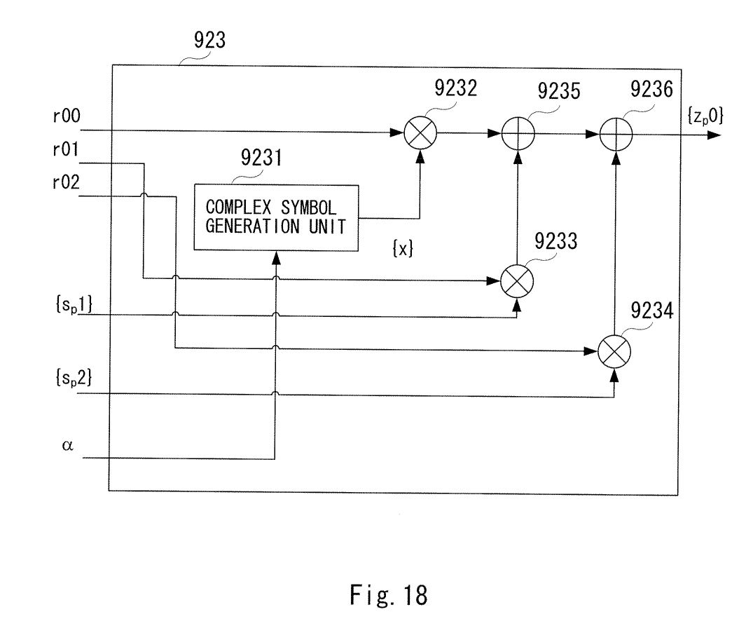

FIG. 18 is a block diagram showing an exemplary configuration of the replica generation unit 923. Referring to FIG. 18, the replica generation unit 923 includes a complex symbol generation unit 9231, three multipliers 9232 to 9234 and two adders 9235 and 9236.

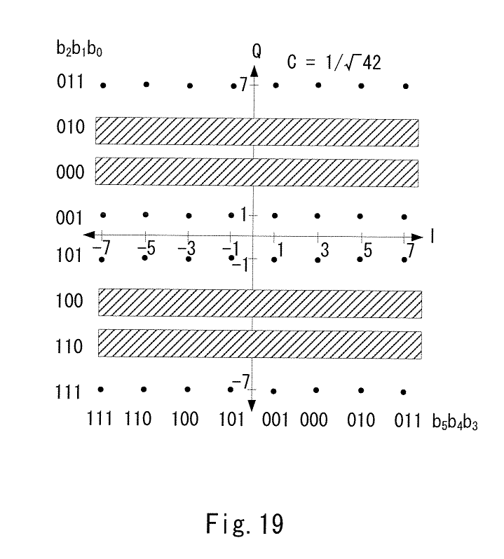

The complex symbol generation unit 9231 receives likelihood information a. Since the eventual probability of transmission symbols is generally the same, all of 64 symbols shown in FIG. 16 are output. On the other hand, when a common redundant bit is contained, the eventual probability of transmission symbols is not the same with the use of the likelihood information a. For example, when b0 contains a common redundant bit of bit 1, the eventual probability of 32 symbols with b0=0 is 0. Thus, only 32 symbols which contain b0=1 are output as shown in FIG. 19. In this manner, only the probable symbol candidates {x} are output by substituting the likelihood information for the eventual probability.

The replica generation unit 924 may be implemented by setting an input from the candidate selection unit 927 to null in the configuration of the replica generation unit 923.

The elements which generate a symbol candidate sequence of a received signal and an error candidate sequence using a result of QR decomposition of the received signal and output the symbol candidate sequence and the error candidate sequence to the inverse mapping unit 928 may be collectively referred to as a candidate generation unit 990. In FIG. 17, the candidate generation unit 990 includes the QR decomposition unit 921, the Q matrix multiplication unit 922, the replica generation units 923-0, 923-1 and 924, the error calculation units 925-0, 925-1 and 926 and the candidate selection units 927-0, 927-1 and 927-2. However, the elements corresponding to the candidate generation unit 990 are not limited thereto. According to this exemplary embodiment, the candidate generation unit 990 characteristically includes the replica generation units 923 and 924 which generate replica using likelihood information.

The effect of reducing a calculation amount according to this exemplary embodiment is described hereinafter. FIG. 19 is a block diagram to describe the exemplary advantage of the replica generation unit in FIG. 17.

When using likelihood information, a replica sequence which is output from the replica generation units 923 contain 32 replica symbols. Accordingly, the error calculation units 925 execute error calculation 32+16*32+16*32=1056 times.

On the other hand, when not using likelihood information, a replica sequence which is output from the replica generation units 923 contain 64 replica symbols. Accordingly, the error calculation is performed 64+16*64+16*64=2112 times. The use of likelihood information enables the reduction of the number of times of calculation to ½.

As described in the foregoing, this exemplary embodiment enables the effective reduction of a calculation amount without causing significant degradation in characteristics by inserting a common redundant bit and performing symbol mapping in the transmitting apparatus and then increasing the likelihood of the common redundant bit in the receiving apparatus, in addition to having the exemplary advantage of the first exemplary embodiment.

### Fifth Exemplary Embodiment

A fifth exemplary embodiment describes a detailed exemplary configuration of a redundant bit insertion unit in the case of inserting a common redundant bit upon mapping. The redundant bit insertion unit which is described in the fifth exemplary embodiment may be applied to each of the above-described exemplary embodiments. Thus, the transmitting apparatus is not described herein.

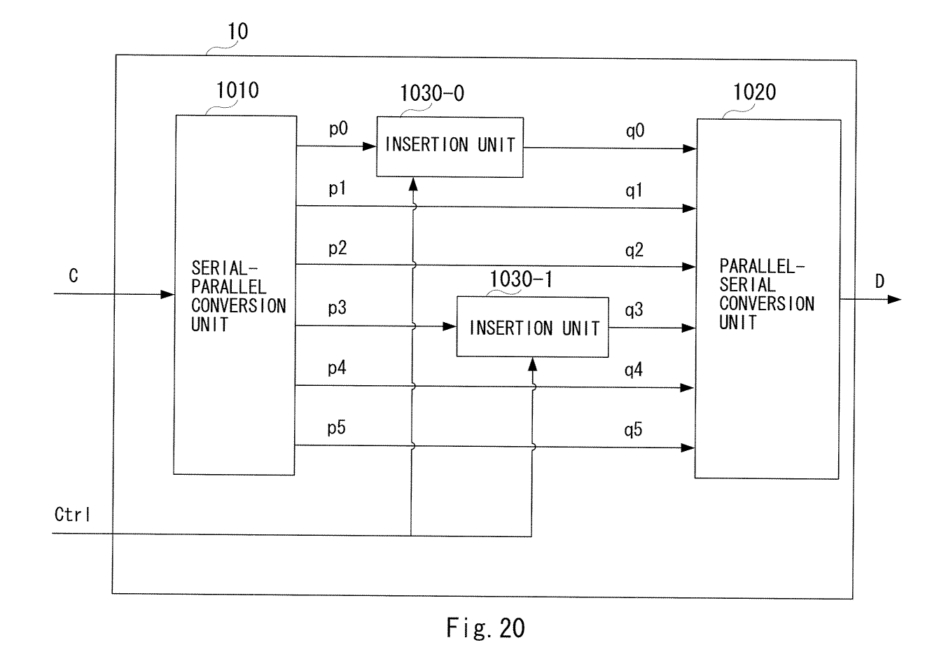

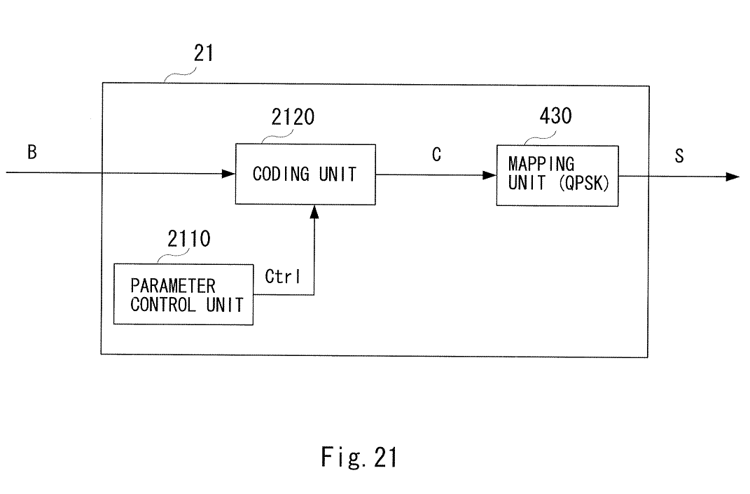

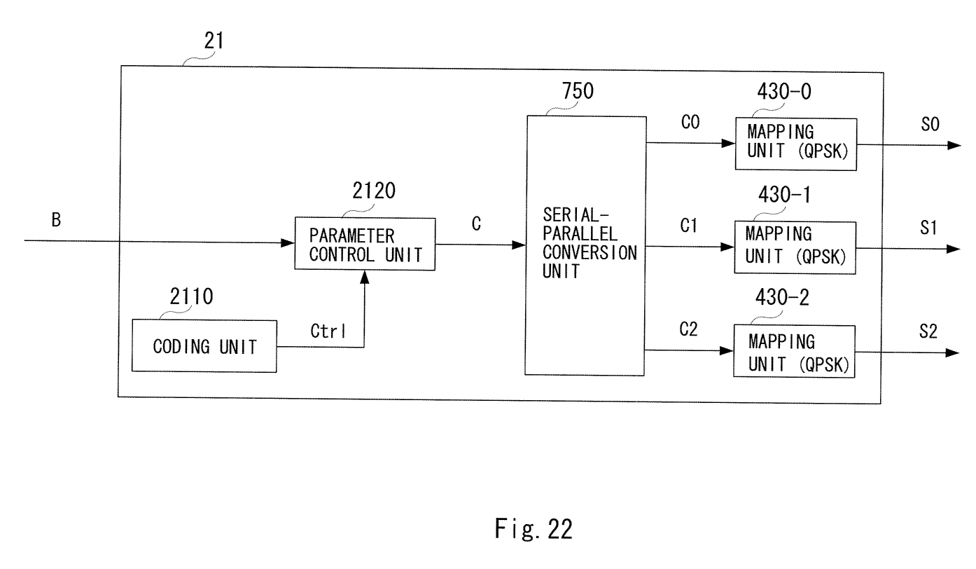

FIG. 20 shows an exemplary configuration of a redundant bit insertion unit 10 according to the fifth exemplary embodiment. Referring to FIG. 20, the redundant bit insertion unit 10 includes a serial-parallel conversion unit 1010, a parallel-serial conversion unit 1020 and insertion units 1030-0 and 1030-1.

The position of inserting a redundant bit is described hereinafter with reference to FIG. 16. In FIG. 16, a distance between adjacent symbols in 64QAM mapping is X. Firstly, regarding b0, a mean distance between a symbol with b0=0 and a symbol with b0=1 that is the closest to b0=0 is figured out. The distance is defined as a mean minimum distance for easier description.

Referring to FIG. 16, because the symbol with b0=1 is always adjacent to the symbol with b0=0, the mean minimum distance is X. On the other hand, regarding b2 in FIG. 16, a symbol with b2=1 is not always adjacent to a symbol with b2=0. Thus, in light of the symmetry of b2=0 and b2=1, the mean minimum distance is (X+2X+3X+4×)/4=2.5X. Since b2 has a larger mean minimum distance than b0, it is more tolerant to errors. In view of the foregoing, this exemplary embodiment inserts a common redundant signal preferentially to a bit position with a low tolerance to errors, such as b0. Specifically, a redundant signal control unit determines an insertion position to insert a common redundant signal based on an error tolerance of a signal to be mapped. A redundant bit insertion unit inserts the common redundant signal into the insertion position based on a control signal Ctrl. FIG. 20 shows an example of such a redundant bit insertion unit.

The operation of the redundant bit insertion unit 10 is described hereinafter. The serial-parallel conversion unit 1010 receives a coded sequence C, converts the coded sequence C into 6 parallel sequences p0 to p5 and outputs them. The sequences p0 to p5 are mapped into b0 to b5, respectively, by the symbol mapping shown in FIG. 16. The insertion units 1030-0 and 1030-1 receive p0 and p3, respectively, and a control signal Ctrl, insert the common redundant bit based on the control signal Ctrl and output coded sequences q0 and q3. The parallel-serial conversion unit 1020 receive coded sequences q0, q1, q2, q3, q4 and q5, converts the coded sequences q0, q1, q2, q3, q4 and q5 into a serial signal and outputs a coded sequence D.

As described above, it is possible to expect the improvement in the reception characteristics by inserting a common redundant bit according to an error tolerance during mapping.

Although a common redundant bit is inserted into p0 and p3 in this exemplary embodiment, it is not limit the embodiments of the present invention, and a common redundant bit may be inserted into a larger number or a smaller number of parallel sequences. The amount and the position of the common redundant bit to be inserted into each parallel sequence are not particularly restricted. Further, this exemplary embodiment describes a case where determination is made based on a bit position in which a mean distance between a bit 0 and a bit 1 after mapping is close in the signal point arrangement of symbol mapping, as an example of determination of an error tolerance during mapping. However, it is not limited thereto, and the determination of an error tolerance during mapping may be made by another method.

### Another Exemplary Embodiment

A communication system according to the present invention includes any one of the receiving apparatus and any one of the receiving apparatus which are described in the above exemplary embodiments.

As described in the foregoing, according to an exemplary embodiment of the present invention, a radio communication system includes a transmitting apparatus which has a redundant signal control unit, a signal coding unit and a signal mapping unit, and a receiving apparatus which has a likelihood holding unit and a signal demodulation unit. The transmitting apparatus inserts a common redundant signal that is known to both the transmitting apparatus and the receiving apparatus in at least one of the signal coding unit and the signal mapping unit. The receiving apparatus holds a likelihood of the common redundant signal in the likelihood holding unit and makes substitution for the likelihood of the common redundant signal when demodulating a signal in the signal demodulation unit. It is thereby possible to expect accurate information rate control and high-performance signal reception.

According to another exemplary embodiment of the present invention, a radio communication system inserts a common redundant signal in accordance with a stream line quality in a transmitting apparatus which includes a plurality of transmission antennas. In a receiving apparatus, the system calculates a likelihood of the common redundant signal and substitutes a predetermined likelihood for a likelihood corresponding to the common redundant signal which is included in the calculated likelihood. It is thereby possible to achieve simplified and high-performance reception.

According to yet another exemplary embodiment of the present invention, a radio communication system includes a transmitting apparatus which controls the amount of common redundant bits to be inserted according to a mean distance of a bit. It is thereby possible to expect accurate rate control and high-performance signal reception.

The present invention enables the transmission and reception of a high-quality signal in radio communication.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A transmitting apparatus to transmit a transmission signal to a receiving apparatus, comprising:
a redundant signal control unit to hold control information for specifying an insertion position and an insertion amount to insert a redundant signal known to the receiving apparatus into an information data sequence; and
a signal coding unit to generate a coded signal sequence by encoding an information data sequence and generate a transmission signal by inserting the redundant signal into the coded signal sequence based on control information held by the redundant signal control unit.

2. The transmitting apparatus according to claim 1, wherein the signal coding unit includes:
a coding unit to encode the information data sequence;
a mapping unit to generate the transmission signal by mapping the coded signal sequence into symbols; and
a redundant signal insertion unit to insert the redundant signal into at least one of the coded signal sequence encoded by the coding unit and the transmission signal generated by the mapping unit.

3. The transmitting apparatus according to claim 1, wherein
the redundant signal control unit determines an insertion position and an insertion amount according to a quality of a propagation path so as to insert a larger amount of redundant signals into a low-quality signal than into a high-quality signal and generates control information for specifying the insertion position and the insertion amount determined.

4. The transmitting apparatus according to claim 2, wherein
the mapping unit and the redundant signal insertion unit include a plurality of mapping units and a plurality of redundant signal insertion units respectively corresponding to a plurality of different propagation paths,
the plurality of redundant signal insertion units insert the redundant signal into coded sequences to be mapped into symbols by the plurality of mapping units, and
the plurality of mapping units generate transmission signals with the same transmission rate.

5. The transmitting apparatus according to claim 4, wherein
the redundant signal control unit generates a plurality of pieces of control information respectively corresponding to the plurality of different propagation paths, and
the plurality of redundant signal insertion units insert the redundant signal into the symbols based on control information corresponding to a propagation path to transit the transmission signal.

6. The transmitting apparatus according to claim 2, wherein
the redundant signal control unit determines an error tolerance based on signal point arrangement to be mapped by the mapping unit and determines an insertion position to insert the redundant signal.

7. A receiving apparatus to receive a coded received signal, comprising:
a likelihood holding unit to hold likelihood information for specifying a likelihood of a redundant signal contained in the received signal; and
a signal demodulation unit to receive the received signal containing the redundant signal and the likelihood information and demodulate the received signal by calculating a likelihood from the received signal and substituting the likelihood information for the likelihood of the redundant signal.

8. The receiving apparatus according to claim 7, wherein the signal demodulation unit includes:
an inverse mapping unit to perform inverse mapping of the received signal, calculate a likelihood of the received signal and output the likelihood as a calculated likelihood;
a first likelihood substitution unit to output a modified likelihood by substituting the likelihood information for a likelihood corresponding to the redundant signal included in the calculated likelihood calculated by the inverse mapping unit; and
a decoding unit to decode the received signal based on the modified likelihood and output a decoded signal.

9. The receiving apparatus according to claim 8, wherein
the likelihood holding unit holds likelihood information corresponding each of a plurality of received signals received from different propagation paths, and
the first likelihood substitution unit makes substitution for the calculated likelihood based on likelihood information corresponding to each of the plurality of received signals.

10. The receiving apparatus according to claim 9, wherein
the inverse mapping unit and the first likelihood substitution unit include a plurality of inverse mapping units and a plurality of first likelihood substitution units respectively corresponding to the different propagation paths, and
the likelihood holding unit outputs likelihood information corresponding to each of the different propagation paths to the plurality of first likelihood substitution units.

11. The receiving apparatus according to claim 8, wherein
the decoding unit calculates a likelihood based on the modified likelihood and output the likelihood as a second calculated likelihood, and
the signal demodulation unit further includes:
a second likelihood substitution unit to output a second modified likelihood by substituting the likelihood information for a likelihood corresponding to the redundant signal included in the second calculated likelihood output from the decoding unit; and
an elimination signal generation unit to generate an elimination signal by eliminating an interference component from the received signal based on the second modified likelihood and output the generated elimination signal to the inverse mapping unit.

12. The receiving apparatus according to claim 9, wherein
the signal demodulation unit further includes a candidate generation unit to generate a symbol candidate sequence of the received signal and an error candidate sequence using a result of QR decomposition of the received signal and output the generated sequences to the inverse mapping unit, and
the candidate generation unit includes a replica generation unit to generate a replica signal using the decomposition result and the likelihood information.

13. The receiving apparatus according to claim 7, wherein
the redundant signal is known information, and
the likelihood holding unit holds a fixed value as the likelihood information.

14. A transmitting method to transmit a transmission signal to a receiving apparatus, comprising:
holding control information for specifying an insertion position and an insertion amount to insert a redundant signal known to the receiving apparatus into an information data sequence;
generating a coded signal sequence by encoding an information data sequence;
generating a transmission signal by inserting the redundant signal into the coded signal sequence based on held control information; and
transmitting the generated transmission signal.

15. A receiving method to receive a coded received signal, comprising:
holding likelihood information for specifying a likelihood of a redundant signal contained in the received signal;
calculating a likelihood from the received signal; and
demodulating the received signal by substituting the likelihood information for a likelihood corresponding to the redundant signal included in the calculated likelihood.

16. A program product, in a computer readable medium, causing a computer to implement a process comprising:
holding control information for specifying an insertion position and an insertion amount to insert a redundant signal known to the receiving apparatus into an information data sequence;
generating a coded signal sequence by encoding an information data sequence; and
generating a transmission signal by inserting the redundant signal into the coded signal sequence based on held control information.

17. A program product, in a computer readable medium, causing a computer to implement a process comprising:
holding likelihood information for specifying a likelihood of a redundant signal contained in the received signal;
calculating a likelihood from the received signal;
generating a modified likelihood by substituting the likelihood information for a likelihood corresponding to the redundant signal included in the calculated likelihood; and
demodulating the received signal based on the generated modified likelihood.
